(19) United States
(12) Patent Application Publication
(10) Pub. No.: US 2005/0005972 A1
(43) Pub. Date: Jan. 13, 2005

(54) Upgrading automatic transmissions

(76) Inventor: Joseph Borg, Victoria (AU)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/493,669

(22) PCT Filed: Jul. 12, 2002
(86) PCT No.: PCT/AU02/00938

(30) Foreign Application Priority Data
Nov. 7, 2001 (AU) PR 8702

(51) Int. Cl. F16K 15/00

(52) U.S. Cl. 137/517

(57) ABSTRACT

A pressure sensitive valve designed to relieve oil pressure accumulation in the 3^{rd}/4^{th} clutch assembly on a Hydramatic 4L60/E automatic transmission is provided. Pressure relief is accomplished by a compression spring and a valve member, located in the valve housing. When unwanted pressure has accumulated in the 3^{rd}/4^{th} clutch circuit (whilst the transmission is in 1^{st} or 2^{nd} gear) the predetermined tension of the compression spring holds the valve member off its seat, thus allowing unwanted oil pressure to flow through the interior space of the housing and exhaust through the orifice. When full oil pressure is applied in the 3^{rd}/4^{th} clutch circuit the compression spring collapses and allows the valve member to seal on the valve seat of the housing. Thus blocking the fluid flow and allowing full oil pressure to apply the 3^{rd}/4^{th} clutch assembly

### FIELD OF THE INVENTION

This invention relates to the upgrading automatic transmissions including a device for carrying out such upgrading.

### BACKGROUND OF THE INVENTION

Automatic transmissions for motor vehicles such as the rear wheel drive General Motors vehicles manufactured in Australia may suffer from cross-leaks in the clutch assemblies forming part of the automatic transmission.

In the case of the 4L60/E transmission manufactured by Hydramatic Corp in Detroit, USA which is fitted to General Motors vehicles, cross-leaks between the sealing rings provided along the turbine shaft of the transmission can cause fluid to leak from the forward apply circuit into the 3^{rd}/4^{th} apply circuit when the transmission is operating in the first or second gear.

The result of this leakage is that the 3^{rd}/4^{th} clutch may partially apply whilst the transmissions in first or second gear with the result that it may burn out the 3^{rd}/4^{th} clutch assembly.

Thus there is a need for modification of such transmission to reduce the risk of 3^{rd}/4^{th} clutch burnout.

### DISCLOSURE OF THE INVENTION

The invention provides a pressure relief valve for the 3^{rd}/4^{th} clutch assembly in an automatic transmission.

Where such leakage is detected, as explained earlier, the build-up of pressure in the housing for the clutch assemblies can lead to burnout of the 3^{rd}/4^{th} clutch. However applicants have found that provision for a valve, which releases this pressure, can have the effect of reducing the likelihood of clutch burnout.

The current 4L60/E transmission includes a valve in the form of a ball capsule assembly, which allows a degree of communication between the housing and the exterior of the housing. However, as it closes with very little application of pressure, it does not adequately deal with the clutch burnout problem associated with cross pressure leakage.

Applicants have found that provision of a valve, which does not close until a predetermined pressure is exceeded, serves to ameliorate this difficulty.

The invention provides a method of modifying an automatic transmission. Which is incorporating a pressure sensitive valve in the transmission, wherein the pressure sensitive valve is set to close when pressure reaches a predetermined limit but is adapted to release pressure built up in the housing of the clutch assembly of the automatic transmission caused by leakage between sealing rings of the turbine shaft if pressure is below that predetermined limit.

Suitably, the valve is set so that it does not close until pressure in the clutch housing exceeds 5 psi. More suitably, it should not close unless pressure exceeds 10 psi.

The valve may be fitted so that it releases cross leak pressure from the 3^{th}/4^{th} apply circuit of the 4L60/E transmission.

Thus in a further aspect, the invention provides an automatic transmission incorporating a pressure sensitive valve which is set to release pressure in the housing of the clutch assembly up to a predetermined limit.

The invention provides a valve for use with an automatic transmission for a vehicle comprising, of,
a housing,
an interior space providing a fluid flow path within the housing,
an inlet to the interior space,
an outlet from the interior space,
a valve member arranged for longitudinal movement within said interior space,
a valve seat in the interior space provided, intermediate to the inlet and outlet, and a resilient means for urging the valve member out of engagement with the valve seat.

Wherein the resilient means are set to allow the valve member to engage the valve seat to shut the valve when pressure of fluid flowing into the inlet exceeds a predetermined limit.

Suitably, the resilient means is a spring. It may be a coil compression spring.

The interior space may be divided into a region of larger diameter near the inlet and a region of smaller diameter near the outlet. The resilient means may be located in the region of smaller diameter.

The valve member may be a ball. It may be held in the region of larger diameter by peening around the inlet.

Preferred embodiments of the invention will now be described with reference to the accompanying drawings.

### BRIEF DESCRIPTION OF THE DRAWINGS

FIG. 1 shows an isometric view of an input clutch housing of a 4L60/E transmission by Hydramatic Corporation USA.

FIG. 2 shows the section Y-Y taken through FIG. 1.

FIG. 3 shows an expanded view of the area surrounding by dotted fines shown in FIG. 2.

FIG. 4 shows an isometric view of a pressure sensitive valve according to the invention.

FIG. 5 shows an inverted view of the pressure sensitive valve of FIG. 4.

FIG. 6 shows the cross-section X-X shown in FIG. 4.

The various integers identified by the reference numerals in the drawings are listed in the following integer list.

Integer List

1 Automatic transmission clutch assembly
3 input housing
5 turbine shaft
7 seal
9 seal
11 seal
13 seal
15 overrun cluch passage
17 forward clutch passage
19 3^{rd}/4^{th} clutch passage
21 lube passage
22 air pressure nozzle
23 output shaft
25 ball valve
26 housing
28 ball
29 valve seat
31 large diameter cavity
33 small diameter passage
35 orifice
37 compression spring
39 forward section of housing
41 peening
43 arrow

### DETAILED DESCRIPTION OF THE PREFERRED EMBODIMENT

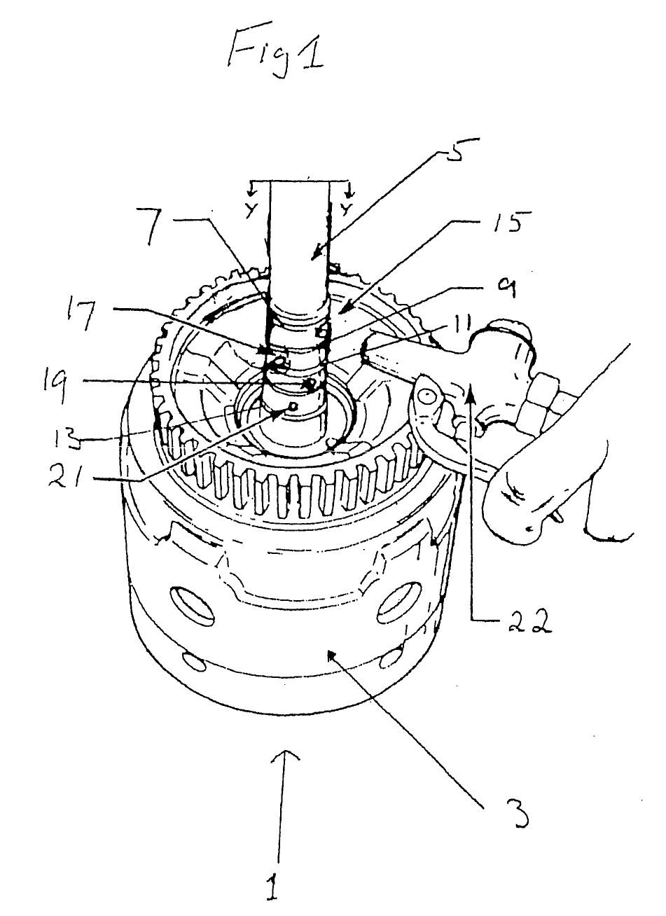

Referring to FIGS. 1 to 3 of the accompanying drawings there is shown a portion of an automatic transmission clutch assembly 1 comprising an input housing 3 and a turbine shaft 5. The particular drawings shown relate to a 4L60/E transmission manufactured by Hydramatic Corporation USA.

The turbine shaft is provided with seals 7,9,11 and 13 fitted into circumferential grooves spaced along the length of the shaft.

The shaft also includes four passages in the form of an overrun clutch passage 15, a forward clutch passage 17, a 3^{rd}/4^{th} clutch passage 19 and a lube passage 21.

Other elements of the clutch assembly are an output shaft 23 and a ball valve 25, which is fitted through an aperture in the input housing.

In the conventional 4L60/E transmission the ball valve comprises a housing 27 having a large diameter cavity 31 for holding a ball 28.

A valve seat 29 is formed at one end of the large diameter cavity and is the entry point to a small diameter passage 33 ending in an orifice 35.

FIG. 3 shows the inclusion of a spring 37 for urging the ball away from the valve seat. This spring is not present in the conventional ball valve found in the 4L60E transmission. Rather, the ball valve is free to move up and down the large diameter cavity without any restriction.

In one possible embodiment of the invention, applicants have added the spring 37 to provide that the ball valve remains open until such time as pressure from the interior of the input housing is to great in pushing against the ball, that the force of the spring is overcome to allow the ball to abut the valve seat and hence close the valve.

Typically, the spring may be set to prevent closure of the modified valve until such time and the pressure rises to 5 psi more preferably at least 10 psi.

By installing a spring to convert the ball valve into a pressure sensitive valve, excess pressure caused by leakage between the seals may be released through the modified ball valve to prevent the 3^{rd}/4^{th} clutch to partially apply and burnout when the transmission is in 1^{st} or 2^{nd} gear.

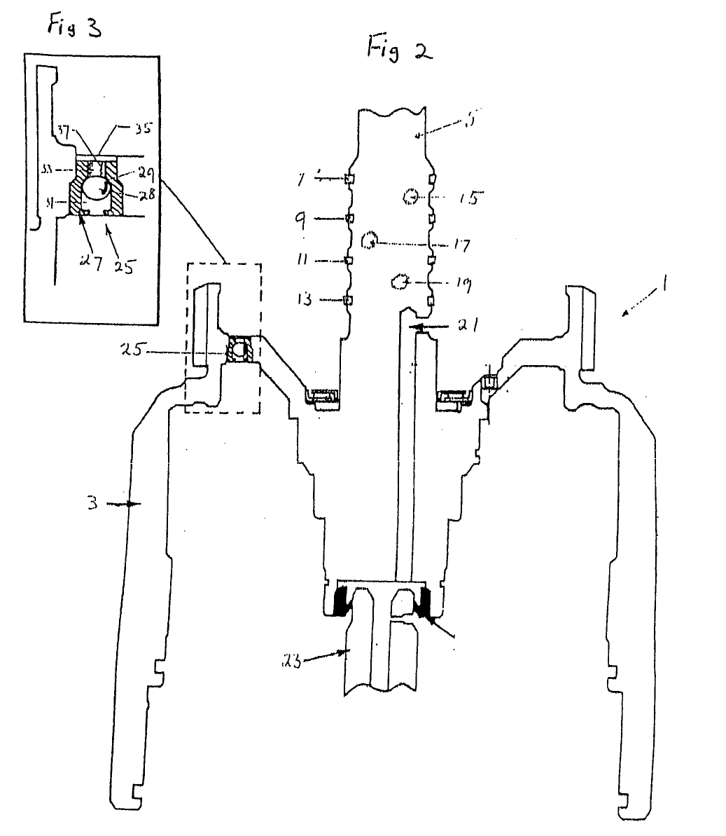

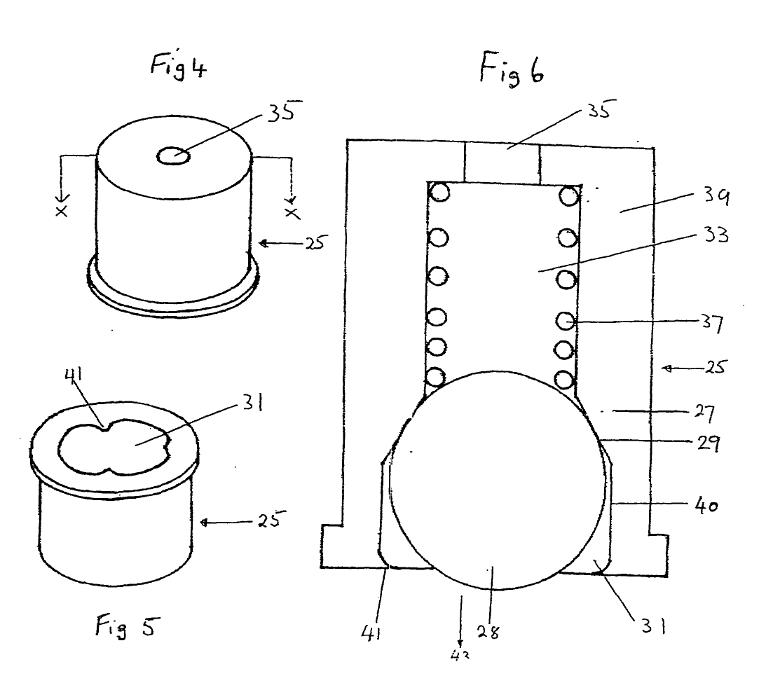

Of course, if the pressure exceeds the predetermined limit as would be required when the transmission is in 3^{rd} or 4^{th} gear, the valve closes and the 3^{rd}/4^{th} clutch applies correctly. Referring to FIGS. 4 to 6 which illustrate a more preferred form of ball valve 25 which may be used to replace the ball valve shown in FIGS. 2 and 3 it can be seen that the main elements of the valves in the two drawings are essentially the same. The reference numerals are therefore the same where the integers they describe are essentially the same.

It can also be seen from the drawing that the ball 28 is held within the large diameter cavity 31 by peening 41. The peening prevents the ball being pushed in the direction of arrow 43 out of the end of the large diameter cavity.

It is to be understood that the word comprising as used throughout the specification is to be interpreted in its inclusive form i.e. Use of the word comprising does not exclude the addition of other elements.

It is to be understood that various modifications of and/or additions to the invention can be made without departing from the basic nature of the invention. These modifications and/or additions are therefore considered to fall within the scone of the invention.

1. A pressure sensitive valve, which comprises of a housing, a valve member and a coil compression spring.

2. A pressure sensitive valve as claimed in claim 1 consisting of an inlet into the interior space of the housing.

3. A pressure sensitive valve as claimed in claim 2, wherein the housing has an interior space providing a fluid flow path.

4. A pressure sensitive valve housing as claimed in claim 2 consisting of an outlet from the interior space.

5. A pressure sensitive valve housing as claimed in claim 2 comprising of a valve seat located between the inlet and outlet of the valve housing.

6. A pressure sensitive valve with a valve member arranged for longitudinal movement within said interior space.

7. A pressure sensitive valve incorporating a resilient means for urging the valve member out of engagement with the valve seat.

8. A pressure sensitive valve incorporating a means of holding the valve member within the inlet of the housing.

9. The pressure sensitive valve may be manufactured from any type of metal.

10. The pressure sensitive valve may be manufactured from any type of plastic.

11. (Cancelled).
